(19) United States
(12) Patent Application Publication
(10) Pub. No.: US 2009/0293839 A1
(43) Pub. Date: Dec. 3, 2009

(54) SYSTEM AND METHOD OF OPTIMIZING AN AUTOMOBILE ENGINE IDLE SPEED BASED ON ACTUAL AIR CONDITIONER USAGE

(76) Inventors: Songping Yu, Troy, MI (US); Hugh Hamilton, Troy, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 12/129,004

(22) Filed: May 29, 2008

(51) Int. Cl. F02M 3/00

(52) U.S. Cl. 123/339.17

(57) ABSTRACT

A system and method for optimizing an automobile engine idle speed based on actual air conditioner usage. The automobile engine may supply power to the air conditioner upon engagement of an air conditioner clutch with the automobile engine. The system may include at least one sensor for transmitting electrical signals representative of air conditioner activities, and a control system for receiving the electrical signals and controlling engagement of the air conditioner clutch with the automobile engine. The control system may determine an air conditioning cycling percentage based on an amount of time the air conditioner clutch is engaged with the automobile engine over an amount of time air conditioning is requested by a user. The control system may adjust an idle engine speed based on the air conditioning cycling percentage to optimize operation of the air conditioner.

### BACKGROUND OF INVENTION

a. Field of Invention

The invention relates generally to vehicle air conditioning systems, and more particularly, to a system and method of controlling the speed of a vehicle air conditioning system power source for efficiently meeting air conditioner power requirements.

b. Description of Related Art

As is known in the art, air conditioning compressors in automotive applications generally rely on a clutch engageable with the automobile engine to receive power. The clutch may be engageable to receive power by means of a rotating shaft from the engine, and may be selectably engageable to maintain sufficient refrigerant pressure for air conditioner operation. Power from the engine may drive a compressor to increase refrigerant pressure to make up for pressure that is lost as the air conditioner operates to cool the air inside the automobile. Increased temperatures, and therefore increased air conditioner system demand, may increase the amount of compression of the refrigerant required. To supply such increased compression, the clutch may be required to remain engaged with the power source for increased periods of time. However, such increased periods of engagement indicate the lack of power in an air conditioner to meet the cooling demand and engine speed needs to be increased accordingly. Moreover, the percentage of time the clutch remains engaged is ideally maintained at a particular percentage, which varies with different air conditioning systems. It would be ideal for the air conditioning system to remain as close to this percentage to optimize efficiency.

While an automobile is in motion, the speed of the engine is determined by a variety of factors such as driving speed and related conditions. However, while an automobile is idling, the speed of the engine idle may be adjusted to optimize the power supplied to the air conditioning system and therefore increase efficiency and decrease fuel consumption. To achieve this optimal efficiency in very hot conditions, a higher engine speed may be required.

Currently, existing systems may be programmed to increase the engine idle speed according to the ambient outdoor temperature. The programmed increase in engine speed may be adjusted to meet the maximum possible demand, rather than the actual demand for air conditioning. Therefore, this adjustment can result in an unnecessarily high engine speed for most users and thus unnecessary fuel consumption. Although this technique may somewhat account for increased air conditioner demand in hot weather, it may not respond to the actual air conditioner usage and achieve the particular ideal air conditioner performance in terms of the percentage of time that the clutch is engaged.

It is therefore desirable to provide an air conditioning system which increases engine idle speed to optimize air conditioner performance and minimize fuel consumption based on actual air conditioner use.

### SUMMARY OF INVENTION

The invention solves the problems and overcomes the drawbacks and deficiencies of prior art air conditioner systems by providing a system and method of optimizing engine idle speed. Specifically, as briefly discussed above, under normal conditions, an air conditioning (AC) compressor may cycle on and off to maintain an appropriate refrigerant pressure for thermodynamic cycles. When the refrigerant pressure is too high, which means the AC output is more than what is being asked for, the compressor may be turned off by disengaging the clutch to protect the hardware. When the refrigerant pressure is low, which means the AC output cannot meet the demand, the compressor may be kept on by continuing clutch engagement. The percentage of the time with the clutch being engaged over the time when AC is requested may be a good indicator of whether AC output meets the real cooling demand. There is an optimal percentage at which an AC system performs at its maximum efficiency. By monitoring this AC cycling percentage and adjusting the engine speed to maintain the percentage value around its optimal, the idle engine speed may be optimized for AC performance without unnecessary compromise of fuel economy.

The present invention system and method thus aims to return the optimal engine rpm for maintaining of the AC for best fuel economy. The method thus monitors the AC cycling and adjusts the engine speed when the clutch is engaged, while further not compromising fuel economy.

In a particular embodiment, the invention provides a system for optimizing an automobile engine idle speed based on actual air conditioner usage. The automobile engine may supply power to the air conditioner upon engagement of an air conditioner clutch with the automobile engine. The system may include at least one sensor for transmitting electrical signals representative of air conditioner activities, and a control system for receiving the electrical signals and controlling engagement of the air conditioner clutch with the automobile engine. The control system may determine an air conditioning cycling percentage based on an amount of time the air conditioner clutch is engaged with the automobile engine over an amount of time air conditioning is requested by a user. The control system may adjust an idle engine speed based on the air conditioning cycling percentage to optimize operation of the air conditioner.

For the system described above, the system may further include at least one sensor for transmitting electrical signals representative of an outdoor ambient temperature. The system may determine a maximum absolute engine idle speed and a proportional gain as functions of the outdoor ambient temperature. The control system may ascertain when the user activates or de-activates the air conditioning, and upon activation of the air conditioning, the control system may set an air conditioning activation time and ascertain whether the air conditioner clutch has cycled. If the air conditioner clutch has cycled, the control system may establish a clutch cycle count upon engagement of the air conditioner clutch, and track a time spent during engagement or disengagement of the air conditioner clutch. The control system may ascertain a number of clutch cycles and a length of time the user requests air conditioning, and compare the number of clutch cycles and the length of time the user requests air conditioning against calibrateable threshold values.

Alternatively, if the air conditioner clutch has not cycled, the control system may ascertain a number of clutch cycles and a length of time the user requests air conditioning, and compare the number of clutch cycles and the length of time the user requests air conditioning against calibrateable threshold values. If the number of clutch cycles and the length of time the user requests air conditioning meets or exceeds the calibrateable threshold values, the control system may calculate a percent time ON if the number of clutch cycles and the length of time the user requests air conditioning exceeds predetermined values. The control system may determine if the air conditioner clutch is ON, and if the air conditioner clutch is ON, the control system may set an ON time and clear an OFF time, and if the air conditioner clutch is OFF, the control system may set an OFF time and clear an ON time.

If the number of clutch cycles and the length of time the user requests air conditioning does not meet or exceed the calibrateable threshold values, the control system may determine if the air conditioner clutch is ON, and if the air conditioner clutch is ON, the control system may set an ON time and clear an OFF time, and if the air conditioner clutch is OFF, the control system may set an OFF time and clear an ON time.

The control system may ascertain an air conditioner clutch state, and if the air conditioner clutch is OFF, the control system may set an engine idle speed request to ‘0’. Alternatively, the control system may ascertain an air conditioner clutch state, and if the air conditioner clutch is ON, the control system may determine an idle engine speed by establishing a rpm gain value, a maximum allowed idle engine rpm value based on outdoor ambient temperature, and a desired ratio of the air conditioner clutch ON time over the air conditioner clutch OFF time. If an actual ratio of the air conditioner clutch ON time over the air conditioner clutch OFF time is different from the desired ratio, the control system may change the idle engine speed to meet the desired ratio.

Alternatively, the control system may ascertain when the user activates or de-activates the air conditioning, and if the user de-activates the air conditioning, the control system may ascertain an air conditioner clutch state, and if the air conditioner clutch is OFF, the control system may set a power source power request to ‘0’. The control system may ascertain when the user activates or de-activates the air conditioning, and if the user de-activates the air conditioning, the control system may ascertain an air conditioner clutch state, and if the air conditioner clutch is ON, the control system may determine an idle engine speed by establishing a rpm gain value, a maximum allowed idle engine rpm value based on outdoor ambient temperature, and a desired ratio of the air conditioner clutch ON time over the air conditioner clutch OFF time. If an actual ratio of the air conditioner clutch ON time over the air conditioner clutch OFF time is different from the desired ratio, the control system may change the idle engine speed to meet the desired ratio.

The invention also provides a method of optimizing an automobile engine idle speed based on actual air conditioner usage, with the automobile engine supplying power to the air conditioner upon engagement of an air conditioner clutch with the automobile engine. The method may include transmitting electrical signals representative of air conditioner activities, and receiving the electrical signals and controlling engagement of the air conditioner clutch with the automobile engine. The method may further include determining an air conditioning cycling percentage based on an amount of time the air conditioner clutch is engaged with the automobile engine over an amount of time air conditioning is requested by a user, and adjusting an idle engine speed based on the air conditioning cycling percentage to optimize operation of the air conditioner.

The method may further include transmitting electrical signals representative of an outdoor ambient temperature, and determining a maximum absolute engine idle speed and a proportional gain as functions of the outdoor ambient temperature. The method may also include ascertaining when the user activates or de-activates the air conditioning, and upon activation of the air conditioning, setting an air conditioning activation time and ascertaining whether the air conditioner clutch has cycled. If the air conditioner clutch has cycled, the method may include establishing a clutch cycle count upon engagement of the air conditioner clutch, and tracking a time spent during engagement or disengagement of the air conditioner clutch. The method may also include ascertaining a number of clutch cycles and a length of time the user requests air conditioning, and comparing the number of clutch cycles and the length of time the user requests air conditioning against calibrateable threshold values.

If the air conditioner clutch has not cycled, the method may include ascertaining a number of clutch cycles and a length of time the user requests air conditioning, and comparing the number of clutch cycles and the length of time the user requests air conditioning against calibrateable threshold values. If the number of clutch cycles and the length of time the user requests air conditioning meets or exceeds the calibrateable threshold values, the method may include calculating a percent time ON if the number of clutch cycles and the length of time the user requests air conditioning exceeds predetermined values. The method may also include determining if the air conditioner clutch is ON, and if the air conditioner clutch is ON, setting an ON time and clearing an OFF time, and if the air conditioner clutch is OFF, setting an OFF time and clearing an ON time.

If the number of clutch cycles and the length of time the user requests air conditioning does not meet or exceed the calibrateable threshold values, the method may include determining if the air conditioner clutch is ON, and if the air conditioner clutch is ON, setting an ON time and clearing an OFF time, and if the air conditioner clutch is OFF, setting an OFF time and clearing an ON time.

The method may also include ascertaining an air conditioner clutch state, and if the air conditioner clutch is OFF, setting an engine idle speed request to ‘0’. The method may also include ascertaining an air conditioner clutch state, and if the air conditioner clutch is ON, determining an idle engine speed by establishing a rpm gain value, a maximum allowed idle engine rpm value based on outdoor ambient temperature, and a desired ratio of the air conditioner clutch ON time over the air conditioner clutch OFF time. If an actual ratio of the air conditioner clutch ON time over the air conditioner clutch OFF time is different from the desired ratio, changing the idle engine speed to meet the desired ratio.

The method may also include ascertaining when the user activates or de-activates the air conditioning, and if the user de-activates the air conditioning, then ascertaining an air conditioner clutch state, and if the air conditioner clutch is OFF, then setting a power source power request to ‘0’. The method may also include ascertaining when the user activates or de-activates the air conditioning, and if the user de-activates the air conditioning, then ascertaining an air conditioner clutch state, and if the air conditioner clutch is ON, then determining an idle engine speed by establishing a rpm gain value, a maximum allowed idle engine rpm value based on outdoor ambient temperature, and a desired ratio of the air conditioner clutch ON time over the air conditioner clutch OFF time. If an actual ratio of the air conditioner clutch ON time over the air conditioner clutch OFF time is different from the desired ratio, then changing the idle engine speed to meet the desired ratio.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a diagram illustrative of a method of operating an air conditioning system according to the present invention.

### DETAILED DESCRIPTION OF THE PREFERRED EMBODIMENTS

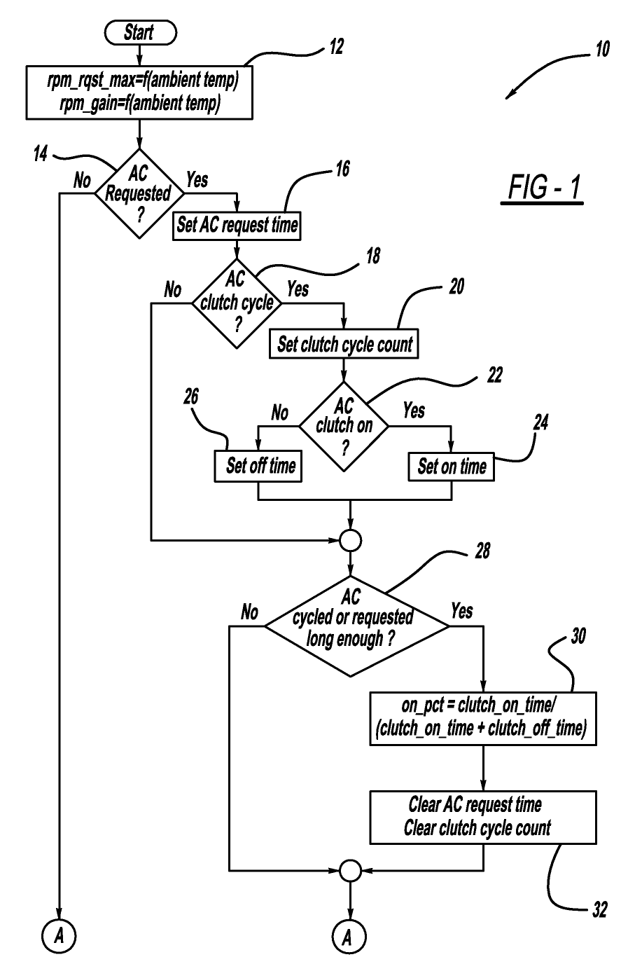

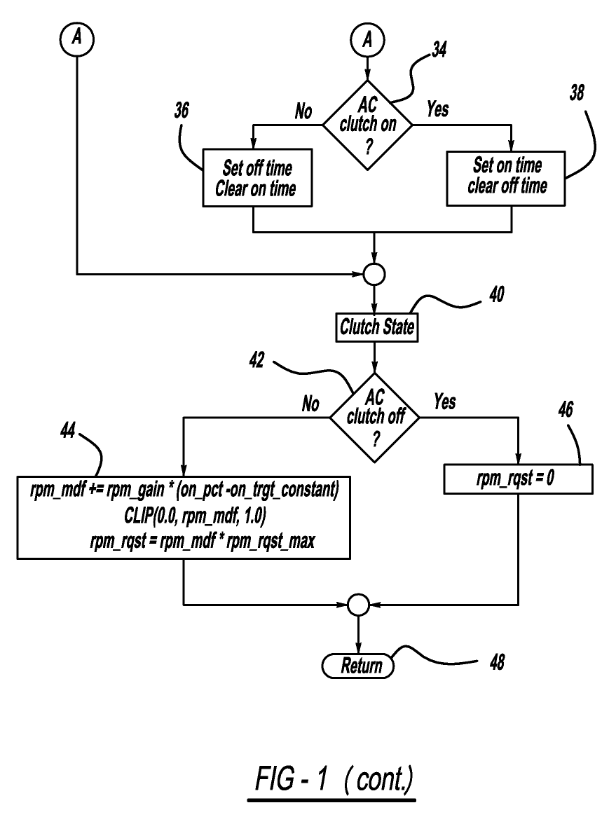

Referring now to the drawing, FIG. 1 illustrates a system and method 10 of optimizing engine idle speed according to the present invention.

The general method of optimizing engine idle speed will first be described in detail, and thereafter, exemplary program steps for the method will be described.

Referring to FIG. 1, in order to optimize engine idle speed, at step 12, a maximum absolute engine speed (e.g., rpm_rqst_max) may be established as a function of outdoor ambient temperature. Also, at step 12, a proportional gain (e.g., rpm_gain) may be established as a function of the outdoor ambient temperature. At step 14, a controller (not shown) may ascertain whether the air conditioner (AC) system has been requested. If YES, at step 16, an AC request time may be established, and at step 18, the controller may ascertain whether an AC clutch mechanism (not shown) has cycled (i.e. has the controller commanded the clutch engaged or disengaged). If the AC clutch mechanism has cycled, at step 20, a cycle count may be established (i.e. the change of state of the clutch may be tracked) and at step 22 the controller may ascertain whether the AC clutch mechanism is engaged (i.e. controller may track the time spent in each state (engaged/disengaged)). If the AC clutch mechanism is engaged at step 22, at step 24, a timer may be set to an ON state. If the AC clutch mechanism is not engaged at step 22, at step 26, the timer may be set to an OFF state. If at step 18, the AC clutch mechanism is not cycled, steps 20, 22, 24 and 26 are bypassed, and at step 28, the controller may ascertain if the AC system has been requested for a predetermined time (i.e. length of time AC system has been requested ON) to establish a steady state according to calibrateable threshold time or AC clutch cycle count values. In other words, at step 28, the controller may check the number of clutch cycles and the length of time the AC system has been requested ON against calibrateable threshold values.

If at step 28 the AC system has been cycled or requested ON for calibrateable threshold values, at step 30, a percentage may be calculated according to how long the AC clutch has been engaged during operation (e.g., on_pct=clutch_on_time/(clutch_on_time+clutch_off_time)). In other words, at step 30, the controller may calculate the percent time ON if the number of clutch cycles or the length of time requested is large enough for valid data. At step 32, the AC request time and the cycle count may be cleared.

If at step 28 the AC system has not been cycled or requested ON for calibrateable threshold values, or after step 32, the controller may ascertain if the AC clutch is engaged at step 34. If the determination at step 34 is NO, at step 36, the controller may establish an OFF time and clear an ON time. If the determination at step 34 is YES, at step 38, the controller may establish an ON time and clear an OFF time.

Thereafter, referring back to step 14 of FIG. 1, if no AC is requested, the controller may bypass the intermediate steps shown and go directly to step 40, where the clutch state is established and ascertained. From steps 36 and 38, the controller may likewise go to step 40. At step 42, the controller may determine if the AC clutch mechanism is OFF. If NO, then at step 44, the following equations may be evaluated:

rpm_mdf+=rpm_gain*(on_pct−on_trgt_constant)

CLIP(0.0, rpm_mdf, 1.0)

rpm_rqst=rpm_mdf*rpm_rqst_max

With regard to the equations in step 44, the controller may first determine the idle engine speed for AC performance using a simple proportional controller. The P gain is “rpm_gain” and the maximum allowed idle engine RPM for AC performance is “rpm_max” which is mainly a function of ambient temperature. A calibration parameter, “on_trgt_constant,” may define the desired ratio of the AC clutch ON time over the AC clutch OFF time, at which the AC has an optimal performance. If the actual ratio is different from the “on_trgt_constant,” then the idle engine RPM will be changed accordingly to achieve the desired ratio. For example, if “on_pct” is 1, which means the AC clutch is ON all the time and its output is not able to meet the customer requirement, (on_pct−on_trgt_constant) is a positive number. This would result in “rpm_mdf” increasing. Therefore the engine speed will increase. Once the engine speed increases, the AC may start to cycle again and “on_pct” will gradually decrease toward “on_trgt_constant” and the engine speed will stabilize. The variable “rpm_mdf” may be clipped to 1 to ensure the engine RPM does not exceed its allowed max.

If the determination at step 42 is YES, then at step 46, the engine rpm increase request (rpm_rqst=0) of zero is returned to the controller.

Exemplary program steps for the method of FIG. 1 will now be briefly discussed.

Specifically, the strategy for optimizing idle engine speed lift based on actual AC performance requirements is based on shifting of the AC engine speed adder logic from the Idle Engine Speed Control (IESC) feature to an Air Conditioner Control (ACC) feature. The final AC RPM adder is input to IESC for arbitration. Generally the ACC feature determines the required RPM adder based on the following logic:

(1) The maximum allowable AC RPM will be a function of the ambient outdoor temperature, and

(2) The AC RPM request is based on AC request and AC cycling patterns. An integral control is used to ensure AC cycles at an optimal level (defined by “acc_ac_on_trgt”) for most efficient AC performance.

For the IESC feature, the following is a partial list of all of the requesters of engine idle speed being processed by Idle Speed Control. The highest engine speed requested may be selected. One of the requesters is the AC Control software (see Step (2) below). It should be noted that the steps below are exemplary, and the IESC feature may include additional or fewer steps, and steps in a different order than those listed below.

idle engine speed request for extended engine idle period;

idle engine speed request for AC performance;

idle engine speed request for alternator operation;

idle engine speed request by transmission operation;

idle engine speed request by power take off operation;

. . .

For the ACC feature, as discussed for step 12 of the method of FIG. 1, the function of step 12 provides the maximum engine speed that can be requested by AC Control software as a function of outside ambient temperature or inferred outside ambient temperature.

As also discussed for step 12 of the method of FIG. 1, the proportional gain may be obtained as a function of ambient temperature at “acc_rpm_gain lookup_{—}2d(&fnacc_rpm_gain, infamb_kam).”

At step 14 of the method of FIG. 1, the controller may evaluate if the AC clutch has been requested ON as follows: if (acrqst!=FALSE).

At step 16 of the method of FIG. 1, the controller may track how long the AC clutch has been requested ON as follows: acc_rqst_tmr++.

At step 18 of the method of FIG. 1, the controller may determine if the AC clutch has changed state as follows: if (accflg!=accflg_pre).

At step 20 of the method of FIG. 1, the controller may determine the AC clutch state change count as follows: acccycle_count=acc_cycle_count+1.

At step 22 of the method of FIG. 1, the controller may determine if the AC clutch is engaged as follows: if (accflg!=FALSE).

At step 24 of the method of FIG. 1, the controller may determine the time the AC clutch is engaged as follows: ace_on_time=acc_on_time+acc_on_tmr.

At step 26 of the method of FIG. 1, the controller may determine the time the AC clutch is disengaged as follows: acc_off_time=acc_off_time+acc_off_tmr.

Once the AC clutch has been requested long enough and has cycled ON and OFF enough for the data to be valid, the percent on time may be calculated, and the counter and timer are reset, respectively, at steps 28, 30 and 32 of the method of FIG. 1 as follows: if (acc_cycle_count>acc_cycle_min∥acc_rqst_tmr>acc_rqst_tm); if (acc_on_time>0.0 && acc_off_time>0.0); acc_ac_on_pct=acc_on_time/(acc_on_time+ace_off_time); acc_ac_on_pct=1.0; acc_cycle_count=0; acc_rqst_tmr=0.0f.

At steps 34, 36 and 38 of the method of FIG. 1, the controller may time the AC clutch ON and OFF times, respectively, as follows: if (accflg!=FALSE); acc_on_tmr++ace_off_tmr=0; acc_on_tmr=0; acc_off_tmr++.

At step 40 of the method of FIG. 1, the controller may capture the last pass state of the AC clutch and thus determine when the clutch changes state as follows: accflg_pre=accflg.

Remaining steps 42, 44 and 46 have been described as shown in FIG. 1. For step 44 of the method of FIG. 1, the equations may be specified as follows:

acc_ac_on_trqt—AC cycle on/off ratio at which AC has max efficiency.

acc_cycle_min—min cycle times to calculate the acc_ac_on_pct.

acc_rqst_tm—min AC requested on time to calculate acc_ac_on_pct.

To summarize, the invention thus provides an air conditioning system which increases engine idle speed to optimize air conditioner performance and while minimizing fuel consumption based on actual air conditioner use.

Those skilled in the art would readily appreciate in view of this disclosure that various modifications may be made to the method described above without departing from the scope of the present invention. For example, rather than calculating a power or rpm gain based on time percentage engagement of a clutch or other power input means, additional sensors may be employed to adjust power to reach an optimal output (i.e. the refrigerant pressure of an air conditioning system may be sampled). Power input to the air conditioning system may be increased or decreased to cause the pressure to reach an ideal, optimized value.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1-13. (canceled)

14. A method of optimizing an automobile engine idle speed based on actual air conditioner usage, the automobile engine supplying power to the air conditioner upon engagement of an air conditioner clutch with the automobile engine, the method comprising:
transmitting electrical signals representative of air conditioner activities;
controlling engagement of the air conditioner clutch with the automobile engine based at least in part on the electrical signals;
determining an air conditioning cycling percentage based on an amount of time the air conditioner clutch is engaged with the automobile engine over an amount of time air conditioning is requested by a user;
comparing the air conditioning cycling percentage with a desired percentage at which the air conditioner has an optimal performance; and
adjusting the engine idle speed based on the comparison of the air conditioning cycling percentage with the desired percentage, the engine idle speed being increased if the air conditioning cycling percentage is above the desired percentage and the engine idle speed being decreased if the air conditioning cycling percentage is below the desired percentage.

15. A method according to claim 14, further comprising transmitting electrical signals representative of an outdoor ambient temperature, and determining a maximum absolute engine idle speed and a proportional gain as functions of the outdoor ambient temperature.

16. A method according to claim 15, further comprising ascertaining when the user activates or de-activates the air conditioning, upon activation of the air conditioning, setting an air conditioning activation time and ascertaining whether the air conditioner clutch has cycled.

17. A method according to claim 16, wherein if the air conditioner clutch has cycled, establishing a clutch cycle count upon engagement of the air conditioner clutch, and tracking a time spent during engagement or disengagement of the air conditioner clutch.

18. A method according to claim 17, further comprising ascertaining at least one of a number of clutch cycles and a length of time the user requests air conditioning, and comparing at least one of the number of clutch cycles and the length of time the user requests air conditioning against respective calibratable threshold values.

19. A method according to claim 16, wherein if the air conditioner clutch has not cycled, ascertaining at least one of a number of clutch cycles and a length of time the user requests air conditioning, and comparing at least one of the number of clutch cycles and the length of time the user requests air conditioning against respective calibratable threshold values.

20. A method according to claim 18, wherein the step of determining an air conditioning cycling percentage is performed only if the at least one of the number of clutch cycles and the length of time the user requests air conditioning meets or exceeds the respective calibratable threshold values.

21. A method according to claim 20, further comprising determining if the air conditioner clutch is ON, if the air conditioner clutch is ON, setting an ON time and clearing an OFF time, if the air conditioner clutch is OFF, setting an OFF time and clearing an ON time.

22. A method according to claim 18, wherein if at least one of the number of clutch cycles and the length of time the user requests air conditioning does not meet or exceed the respective calibratable threshold values, determining if the air conditioner clutch is ON, if the air conditioner clutch is ON, setting an ON time and clearing an OFF time, if the air conditioner clutch is OFF, setting an OFF time and clearing an ON time.

23. A method according to claim 21, further comprising ascertaining an air conditioner clutch state, if the air conditioner clutch is OFF, setting an engine idle speed adjustment request to ‘0’.

24. A method according to claim 21, further comprising ascertaining an air conditioner clutch state, if the air conditioner clutch is ON, determining an idle engine speed by establishing a rpm gain value, a maximum allowed idle engine rpm value based on outdoor ambient temperature, and a desired ratio of the air conditioner clutch ON time over the air conditioner clutch OFF time, if an actual ratio of the air conditioner clutch ON time over the air conditioner clutch OFF time is different from the desired ratio, changing the idle engine speed to meet the desired ratio.

25. A method according to claim 15, further comprising ascertaining when the user activates or de-activates the air conditioning, if the user de- activates the air conditioning, then ascertaining an air conditioner clutch state, if the air conditioner clutch is OFF, then setting a power source power request to ‘0’.

26. A method according to claim 15, further comprising ascertaining when the user activates or de-activates the air conditioning, if the user de-activates the air conditioning, then ascertaining an air conditioner clutch state, if the air conditioner clutch is ON, then determining an idle engine speed by establishing a rpm gain value, a maximum allowed idle engine rpm value based on outdoor ambient temperature, and a desired ratio of the air conditioner clutch ON time over the air conditioner clutch OFF time, if an actual ratio of the air conditioner clutch ON time over the air conditioner clutch OFF time is different from the desired ratio, then changing the idle engine speed to meet the desired ratio.

27. A method of controlling an automobile engine idle speed based on actual air conditioner usage, the automobile engine supplying power to the air conditioner upon engagement of an air conditioner clutch with the automobile engine, the method comprising:
controlling engagement of the air conditioner clutch with the automobile engine based at least in part on whether air conditioning is requested by a user;
ascertaining at least one of a number of clutch cycles and a length of time the user requests air conditioning;
comparing at least one of the number of clutch cycles and the length of time the user requests air conditioning against respective calibratable threshold values;
if the at least one of the number of clutch cycles and the length of time the user requests air conditioning meets or exceeds the respective calibratable threshold values, calculating an air conditioning cycling percentage defined as an amount of time the air conditioner clutch is engaged with the automobile engine over an amount of time air conditioning is requested by the user;
comparing the air conditioning cycling percentage with a desired percentage at which the air conditioner has an optimal performance; and
increasing the engine idle speed if the air conditioning cycling percentage is above the desired percentage and decreasing the engine idle speed if the air conditioning cycling percentage is below the desired percentage.
